(19) United States
(12) Patent Application Publication
(10) Pub. No.: US 2016/0156798 A1
(43) Pub. Date: Jun. 2, 2016

(54) IMAGE FORMING APPARATUS, IMAGE FORMING APPARATUS CONTROL METHOD, AND STORAGE MEDIUM STORING PROGRAM

(71) Applicant: CANON KABUSHIKI KAISHA, Tokyo (JP)

(72) Inventor: Xiaoli Wang, Tokyo (JP)

(21) Appl. No.: 14/944,513

(22) Filed: Nov. 18, 2015

(30) Foreign Application Priority Data
Nov. 27, 2014 (JP) 2014-240365

(51) Int. Cl. H04N 1/00; H04N 1/21

(52) U.S. Cl. CPC H04N 1/00896; H04N 1/2158; H04N 1/00938; H04N 2201/0094; H04N 2201/0093

(57) ABSTRACT

An image forming apparatus acquires information of a storage, and determines, based on the information of the storage, either of the first power saving state and the second power saving state to which the image forming apparatus shifts when shifting to a power saving state.

### BACKGROUND OF THE INVENTION

1. Field of the Invention

The present invention relates to an image forming apparatus having a plurality of power states, an image forming apparatus control method, and a storage medium storing a program.

2. Description of the Related Art

An image forming apparatus generally has a power saving function of shifting to a sleep state when the user has not accessed the image forming apparatus for a predetermined time. The image forming apparatus has a function of returning from the sleep state in response to various factors such as a notification from the outside such as a network or a device such as a facsimile device, and detection of pressing of a power saving key. One sleep state is a deep sleep state in which power feeding to a CPU and a hard disk (HDD) is stopped (Japanese Patent Laid-Open No. 2013-246491). Japanese Patent Laid-Open No. 2013-246491 describes that power feeding to a CPU in a controller is stopped by a semiconductor switch.

When executing a service having a restriction on the response time to a notification from a network, a facsimile device, or the like, the image forming apparatus needs to send back a response within a predetermined time. For example, when executing an IP-FAX function, if the image forming apparatus does not send back a response within a predetermined time upon receiving a specific request from an external apparatus, the communication is sometimes canceled.

When the HDD requires a spin-up time at the time of return from the sleep state, if the image forming apparatus receives a specific request after shifting to the deep sleep state, it cannot send back a response within the predetermined time. To send back a response within the predetermined time in the above case, the second sleep state in which power consumption is higher than that in the deep sleep state and power feeding to the HDD is maintained is sometimes set. In this case, a response within the predetermined time becomes possible by shifting to the second sleep state while maintaining power feeding to the HDD.

A case will be examined, in which an SSD (Solid State Drive) is mounted instead of the HDD in order to improve the performance of the image forming apparatus. The SSD does not have the spin-up time, unlike the HDD, and does not require the time for activation. When the SSD is mounted, the image forming apparatus can send back a response within the predetermined time without any problem even upon shifting to the deep sleep state.

However, if the image forming apparatus shifts to the second sleep state, as in the case in which the HDD is mounted, power is wastefully consumed. A sleep state serving as a shift destination can be changed by rewriting control software at the same time as change of mounting from the HDD to the SSD. However, the rewrite of control software requires extra cost and labor and is not easy.

### SUMMARY OF THE INVENTION

An aspect of the present invention is to eliminate the above-mentioned problems with the conventional technology. The present invention provides an image forming apparatus that appropriately performs the shift of the apparatus to a low power consumption state, an image forming apparatus control method, and a storage medium storing a program.

The present invention in one aspect provides an image forming apparatus having a standby state, and a power saving state in which power consumption is lower than power consumption in the standby state, the power saving state including a first power saving state in which power supply to a storage is stopped, and a second power saving state in which power supply to the storage is maintained, comprising: an acquisition unit configured to acquire information of the storage; and a determination unit configured to determine, based on the information of the storage that is acquired by the acquisition unit, one of the first power saving state and the second power saving state to which the image forming apparatus shifts when the image forming apparatus shifts to the power saving state.

According to the present invention, the shift of the apparatus to a low power consumption state can be appropriately performed.

Further features of the present invention will become apparent from the following description of exemplary embodiments with reference to the attached drawings.

### BRIEF DESCRIPTION OF THE DRAWINGS

FIG. 1 is a block diagram showing the arrangement of an image forming system;

FIG. 2 is a view showing an operation unit;

FIG. 3 is a block diagram showing the block arrangement of a controller;

FIG. 4 is a block diagram showing the power feeding state of the controller in a deep sleep mode;

FIG. 5 is a block diagram showing the power feeding state of the controller in a second sleep mode;

FIG. 6 is a block diagram showing the relationship between a CPU, an HDD, and a SMART information storage unit;

FIG. 7 is a table showing an example of a description regarding SMART information;

FIG. 8 is a flowchart showing the procedures of shift control processing to the sleep mode;

FIG. 9 is another flowchart showing the procedures of shift control processing to the sleep mode;

FIG. 10 is a flowchart showing the procedures of processing of shifting an image forming apparatus to the sleep mode; and

FIG. 11 is still another flowchart showing the procedures of shift control processing to the sleep mode.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same reference numerals denote the same parts, and a repetitive description thereof will be omitted.

[System Arrangement]

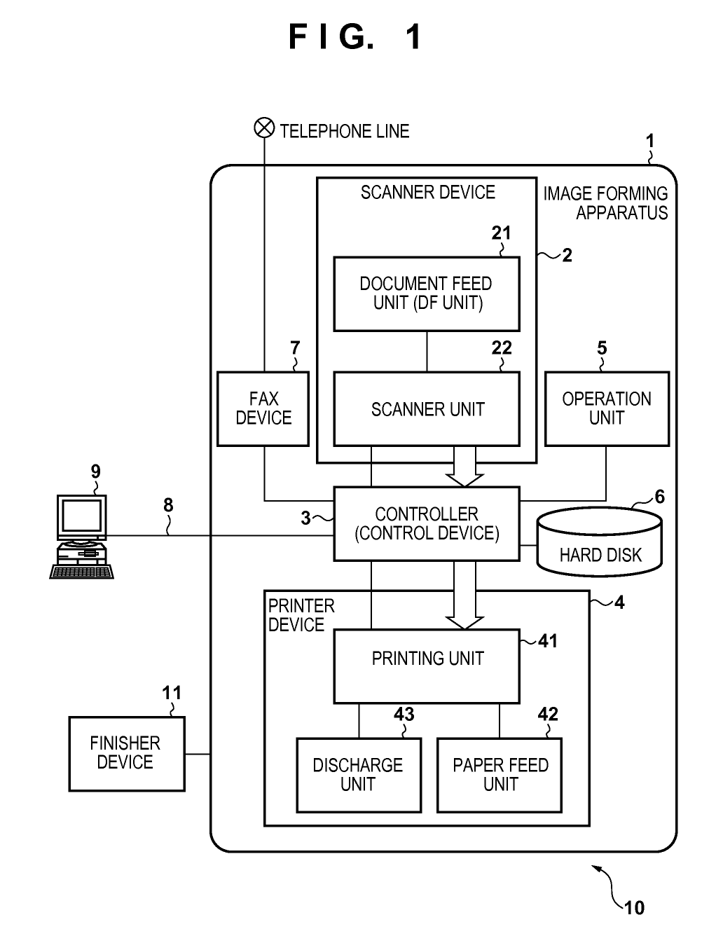

FIG. 1 is a block diagram showing the arrangement of an image forming system. An image forming system 10 includes an image forming apparatus 1 and a computer 9. As the image forming apparatus 1 that performs image forming processing, for example, an MFP (Multi Functional Peripheral) integrally having a plurality of functions such as a print function, scanner function, and data communication function is used. As the computer 9, for example, a general-purpose PC is used. The image forming apparatus 1 and the computer 9 are connected to each other via a network 8 such as a LAN so that they can communicate with each other. The image forming apparatus 1 receives various jobs from the computer 9 and executes image forming processing. This image forming processing is processing of forming an image based on image data and outputting it, and is processing that is performed by executing functions such as scanning, printing, and FAX. The number of computers 9 is not limited to one, and a plurality of computers 9 may be connected to the network 8. The network 8 may be a wired or wireless network.

The image forming apparatus 1 will be explained. A scanner device 2 optically reads a document set on a platen glass or a document supplied from an ADF (Auto Document Feeder), and generates digital image data (to be simply referred to as image data hereinafter). A printer device 4 prints on a printing medium such as a printing sheet based on image data generated by the scanner device 2, image data received from the computer 9, or the like.

An operation unit 5 includes a touch panel and hardware keys for accepting an instruction operation from the user to the image forming apparatus 1, and displaying an apparatus state, a job processing state, and the like. A hard disk (HDD) 6 stores image data, programs for implementing operations according to the embodiment, and the like. A FAX device 7 transmits/receives data via a telephone line or the like. A controller 3 is connected to the scanner device 2, the printer device 4, the operation unit 5, the HDD 6, and the FAX device 7, controls the respective units based on a job, and executes functions implementable by the image forming apparatus 1.

The image forming apparatus 1 performs input/output of image data from the computer 9 via the network 8, and reception of jobs and instructions to the respective devices. The scanner device 2 includes a document feed unit (ADF) 21 that can automatically exchange document bundles sequentially, and a scanner unit 22 that includes a light source and image sensor for optically scanning a document and converts an analog signal into image data. Image data converted by the scanner device 2 is transmitted to the controller 3.

The printer device 4 includes a paper feed unit 42 capable of sequentially feeding sheets one by one from a printing sheet bundle, a printing unit 41 for printing on a fed printing sheet, and a discharge unit 43 for discharging a printed sheet. A finisher device 11 performs finishing processes such as discharge, sorting, stapling, punching, and cutting on printing sheets output from the discharge unit 43 of the printer device 4.

A power saving state implemented by the power saving function of the image forming apparatus 1 will be explained. The image forming apparatus 1 has a plurality of power states. One is a waiting state in which an instruction can be accepted from the user to execute a function. This waiting state will be called a standby mode (standby state). One is a power saving state in which power feeding (power supply) to some devices of the image forming apparatus 1 is stopped. This power saving state will be called a sleep mode (sleep state). The power consumption is lower in the sleep mode than in the standby mode.

The image forming apparatus 1 can execute, as power saving functions, an auto sleep time setting function, an auto sleep shift time setting function, an auto shutdown time setting function, and an auto shutdown shift time setting function.

The auto sleep time setting function (auto sleep time) is a function of setting a day of the week and time when the user wants to shift the image forming apparatus 1 to the sleep mode, and shifting the image forming apparatus 1 to the sleep mode at the designated time. The auto sleep shift time setting function (auto sleep timer) is a function of setting a predetermined time by the user, and when the user has not operated the image forming apparatus 1 for the predetermined time, shifting the image forming apparatus 1 to the sleep mode.

The auto shutdown time setting function (auto shutdown time) is a function of setting a day of the week and time when the user wants to shut down the image forming apparatus 1, and shifting the image forming apparatus 1 to the power-off state at the designated time. The auto shutdown shift time setting function (auto shutdown timer) is a function of setting a predetermined time by the user, and when the user has not operated the image forming apparatus 1 for the predetermined time, shifting the image forming apparatus 1 to the power-off state.

In this embodiment, a state transition of the image forming apparatus 1 from the sleep mode to the standby mode will be called sleep return. The image forming apparatus 1 also has a sleep return time setting function. The sleep return time setting function (sleep return time) is a function of setting, by the user, desired time at which the image forming apparatus 1 is in the standby mode, and returning the image forming apparatus 1 from the sleep mode to the standby mode at the time. In this case, for example, a print engine is warmed up, and then the user can print at the set time. The time obtained by subtracting the warm-up time of the fixing unit from the set time is the time when the image forming apparatus 1 returns from the sleep mode to the standby state.

An example of functions executable by the image forming apparatus 1 based on a job will be explained below.

[Image Print Function]

The image forming apparatus 1 executes an image print function of analyzing, for example, a job described in a page description language transmitted from the computer 9 via the network 8, and printing by the printer device 4.

[Copy Function]

The image forming apparatus 1 executes a copy function of storing image data acquired from the scanner device 2 in the HDD 6, and printing on a printing sheet by the printer device 4 based on the image data.

[Image Transmission Function]

The image forming apparatus 1 executes an image transmission function of transmitting image data acquired from the scanner device 2 to the computer 9 via the network 8.

[Image Save Function]

The image forming apparatus 1 executes an image save function of storing image data acquired from the scanner device 2 in the HDD 6, and if necessary, performing transmission of the image data and printing based on the image data.

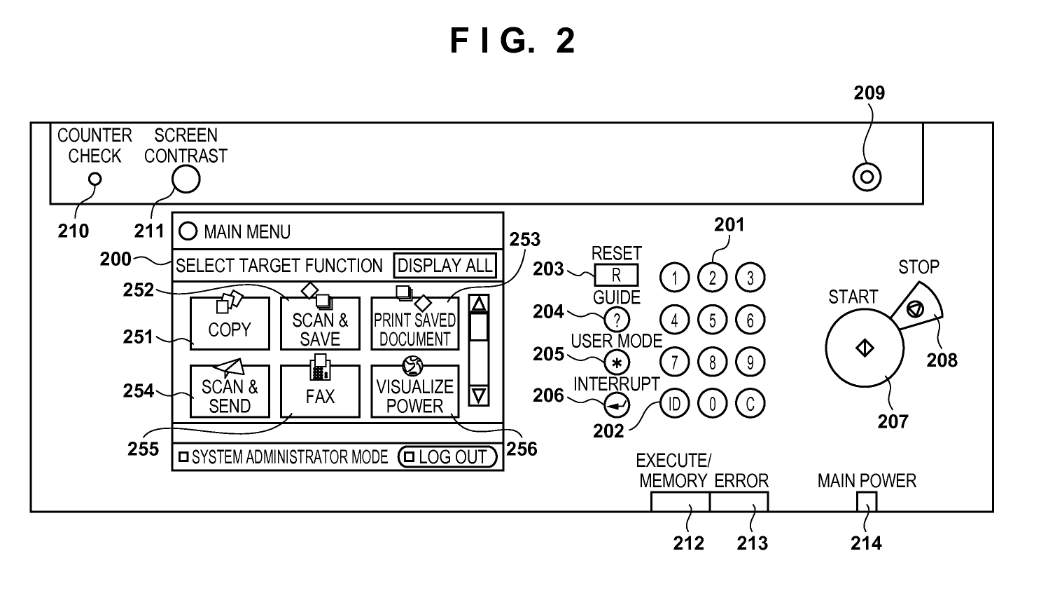

FIG. 2 is a view showing an example of the operation unit 5 in FIG. 1. Note that the operation unit 5 is connected to the controller 3, constituted by an LCD touch panel and the like, and provides the user with a user interface for operating the image forming apparatus 1.

An LCD touch panel 200 performs acceptance of an instruction for a mode setting or the like, and display of the status of the apparatus and a job. A ten-key pad 201 includes keys for accepting an input operation of numerical values from 0 to 9. An ID key 202 is used to input identification information of a department and a password code (for example, password) when, for example, the apparatus is managed for each department. A reset key 203 is a key for resetting set contents. A guide key 204 is a key for displaying an explanation screen for each function. A user mode key 205 is a key for displaying a user mode screen for a general user different from a user having special authority, such as an administrator.

An interrupt key 206 is a key for performing an interrupt operation for an execution target function (for example, printing). A start key 207 is a key for designating the start of execution of an execution target function. A stop key 208 is a key for stopping a function in execution.

A power saving key 209 is a key for shifting the image forming apparatus 1 to the sleep mode. When the user presses the power saving key 209, the backlight of the LCD touch panel 200 is turned off, and the image forming apparatus 1 shifts to the sleep mode. When the user presses a counter check key 210, a count screen representing a total copy count used so far is displayed on the LCD touch panel 200. An adjustment key 211 is a key for adjusting the contrast of the LCD touch panel 200.

An LED 212 is an LED representing a job status such that a job is being executed, or image data is being accumulated in an image memory. An LED 213 is an LED representing the error state of the image forming apparatus 1, such as a jam or opening of a door. An LED 214 is an LED representing that the main switch of the image forming apparatus 1 is ON.

Keys 251, 252, 253, 254, 255, and 256 correspond to respective functions executable by the image forming apparatus 1, and are keys for executing the respective functions of copy, scan & save, printing of a saved document, scan & send, FAX, and power visualization. The key 251 is a key for transiting to the screen of a copy function. The key 252 is a key for transiting to the setting screen of a function of saving image data scanned by the scanner device 2 in the HDD 6. The key 253 is a key for transiting to the setting screen of a function of printing, by the printer device 4, image data saved in the HDD 6.

The key 254 is a key for transiting to the setting screen of a function of sending image data scanned by the scanner device 2 to the computer 9 via the network 8. The key 255 is a key for transiting to the setting screen of a function of printing, by using the printer device 4, data received by the FAX device 7 from a telephone line. The key 256 is a key for transiting to the setting screen of a function of enabling to confirm the power state of the image forming apparatus 1 on the LCD touch panel 200. Although the respective setting screens are not shown, they include software keys for accepting instructions to start execution of the respective functions.

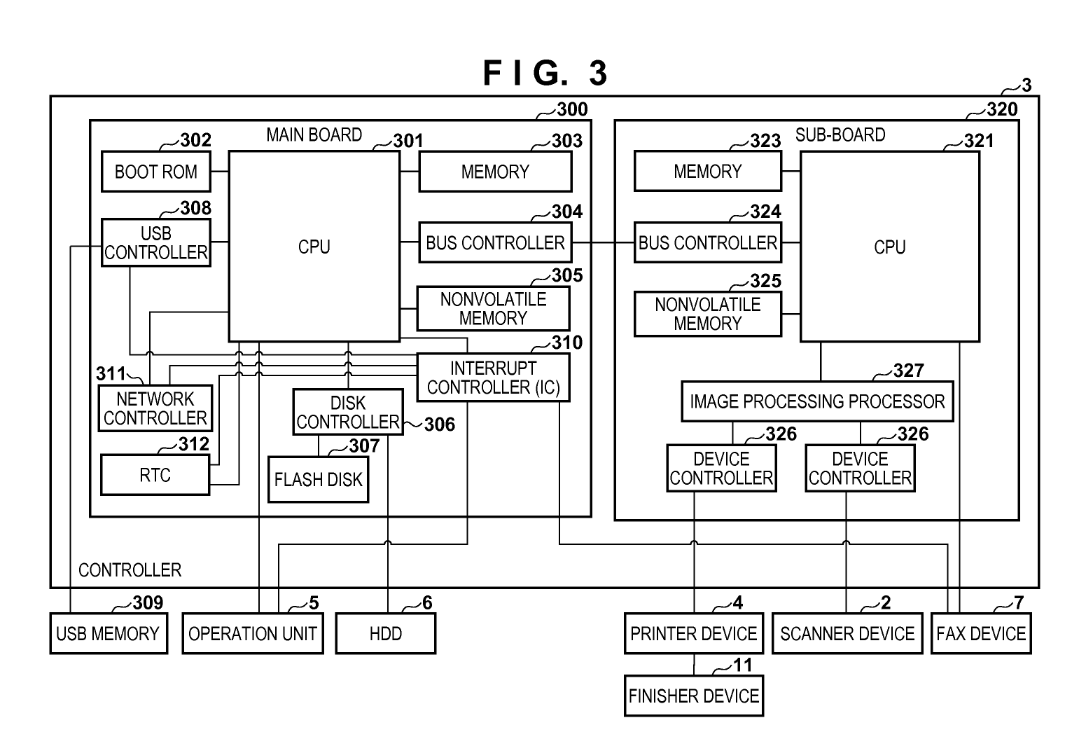

FIG. 3 is a block diagram showing the block arrangement of the controller 3 in FIG. 1. FIG. 3 shows the block arrangement of the controller 3 in the standby state. As shown in FIG. 3, power is supplied to all the devices of the controller 3.

In FIG. 3, the controller 3 includes a main board 300 and a sub-board 320. The main board 300 is a so-called general-purpose CPU system. The main board 300 includes a CPU 301 that controls the overall board, a boot ROM 302 that stores a boot program, a memory 303 usable as the work memory of the CPU 301, a bus controller 304 having a bridge function with an external bus, and a nonvolatile memory 305.

The main board 300 further includes a disk controller 306 that controls a storage, a relatively small-capacity flash disk 307 constituted by a semiconductor device, and a USB controller 308 capable of controlling a USB. A USB memory 309, the operation unit 5, and the HDD 6 are connected as external devices to the main board 300. The USB memory 309 is connected to the USB controller 308, and the HDD 6 is connected to the disk controller 306. The operation unit 5 is connected to the CPU 301 and an interrupt controller 310. The CPU 301 is connected to the interrupt controller 310, and is further connected to a network controller 311, a real-time clock (RTC) 312, the FAX device 7, the operation unit 5 including the power saving key 209, and the USB controller 308.

The sub-board 320 includes a general-purpose CPU system smaller in scale than the main board 300, and image processing hardware. The sub-board 320 includes a CPU 321 that controls the overall board, a memory 323 used as the work memory of the CPU 321, a bus controller 324 having a bridge function with an external bus, and a nonvolatile memory 325. The sub-board 320 further includes an image processing processor (image processor) 327 that performs real-time digital image processing, and device controllers 326.

The scanner device 2 and printer device 4 that are connected to the sub-board 320 transmit/receive image data to/from the image processing processor 327 via the corresponding device controllers 326. The CPU 321 directly controls the FAX device 7. The finisher device 11 performs finishing processing on sheets discharged from the printer device 4.

Note that FIG. 3 is a block diagram and is simplified. For example, the CPUs 301 and 321 include many CPU peripheral hardware components such as a chip set, bus bridge, and clock generator, but are not shown in FIG. 3. The operation of the controller 3 will be explained by exemplifying an image data copy function.

When the user designates execution of the image data copy function on the operation unit 5, the CPU 301 sends an image reading instruction to the scanner device 2 via the CPU 321. The scanner device 2 optically scans the document to generate image data and input it to the image processing processor 327 via the device controller 326. The image processing processor 327 performs DMA transfer to the memory 323 via the CPU 321, and temporarily saves the image data. When the CPU 301 confirms that a predetermined amount or all of the image data has been stored in the memory 323, it sends an image output instruction to the printer device 4 via the CPU 321.

The CPU 321 notifies the image processing processor 327 of the storage position (address) of the image data in the memory 323. The image data in the memory 323 is transmitted to the printer device 4 via the image processing processor 327 and the device controller 326 in accordance with a sync signal from the printer device 4. The printer device 4 prints on a printing sheet based on the image data.

When performing printing by a plurality of copies, the CPU 301 stores, in the HDD 6, image data in the memory 323. This configuration can send the image data to the printer device 4 for the second and subsequent copies without acquiring the image data from the scanner device 2.

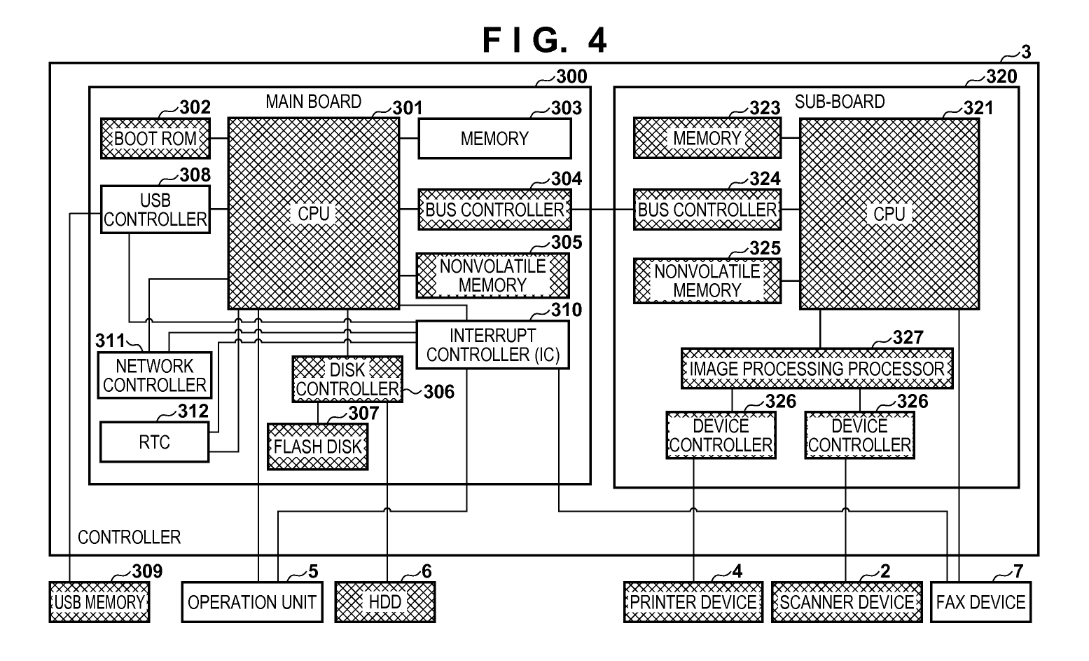

FIG. 4 is a block diagram showing the power feeding state of the controller 3 in the sleep mode. For example, when a predetermined time has elapsed in a state in which no operation has been accepted from the user, or when the power saving key 209 on the operation unit 5 is pressed, the image forming apparatus 1 shifts to the sleep mode in which the power consumption amount is suppressed.

In the sleep mode, power feeding is maintained for only minimum portions necessary for a return operation from the sleep mode, such as the memory 303 and the interrupt controller 310 in the controller 3. In the sleep mode according to this embodiment, power is fed to only portions that notify the interrupt controller 310 of a sleep return interrupt. More specifically, power is fed to only the network controller 311, the RTC 312, the USB controller 308, the power saving key 209 on the operation unit 5, various sensors, and part of the FAX device 7.

That is, in the sleep mode, power is fed to portions other than hatched ones in FIG. 4, and no power is fed to the hatched portions. In the sleep mode, when the network controller 311 detects a network incoming call, or when the RTC 312 detects a timer or an alarm, the interrupt controller 310 receives an interrupt notification from the portion concerned. In the sleep mode, when the FAX device 7 detects an incoming call or off-hook, or when the power saving key 209 detects pressing of the key, the interrupt controller 310 receives an interrupt notification from the portion concerned. Also, when a sensor detects a target object, or when the USB controller 308 detects insertion/removal of a USB or communication, the interrupt controller 310 receives an interrupt notification from the portion concerned.

Upon receiving an interrupt notification, the interrupt controller 310 notifies the CPU 301 of it. Upon receiving the notification, the CPU 301 performs processing of returning the power feeding state or software state to a normal state. Sleep return is performed in accordance with system specifications. Since power feeding portions in the sleep mode are determined based on system specifications for sleep return, they may be different from the portions shown in FIG. 4.

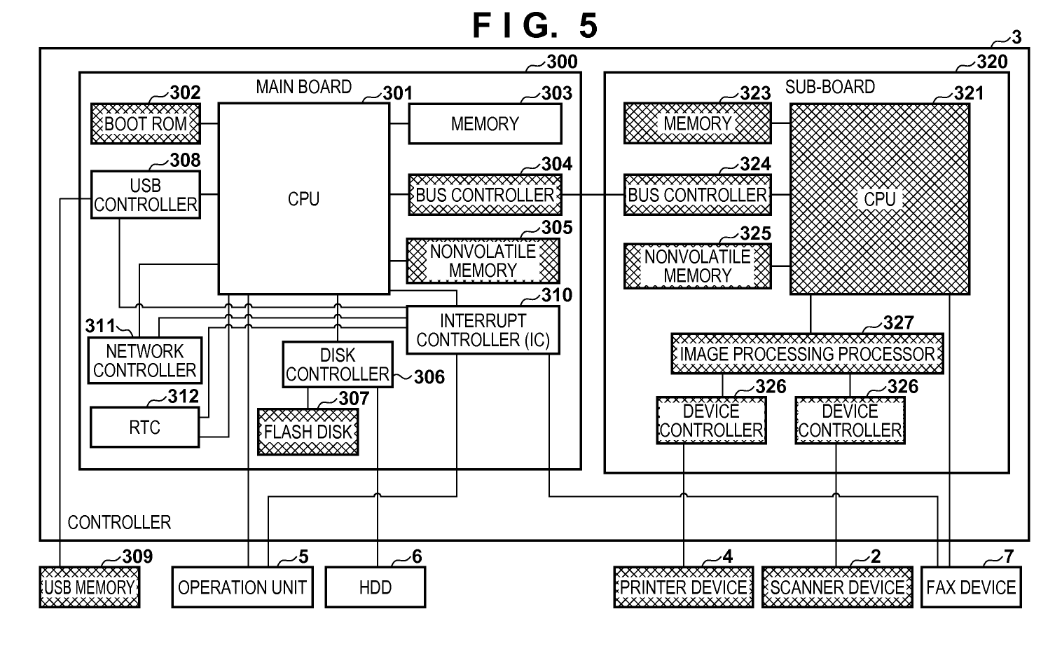

FIG. 5 is a view showing the power feeding state of the controller 3 in the second sleep mode. The operation of the controller 3 will be explained with reference to FIG. 5. In this embodiment, the sleep mode includes a sleep mode higher in power consumption than the sleep mode shown in FIG. 4, in addition to the state shown in FIG. 4. To discriminate these two sleep modes, the sleep mode shown in FIG. 4 will be called a deep sleep mode, and the sleep mode shown in FIG. 5 will be called a second sleep mode (connected sleep mode).

In this embodiment, performance information of a device, particularly, the HDD 6 in the image forming apparatus is acquired, and the image forming apparatus 1 shifts from the standby mode to the deep sleep mode or the second sleep mode based on the performance information. As shown in FIG. 5, in the second sleep mode, power feeding is maintained even for the CPU 301, the disk controller 306, and the HDD 6, unlike the deep sleep mode. In the second sleep mode, sleep return can be performed in response to interrupt notifications from the CPU 301, the disk controller 306, and the HDD 6 to the interrupt controller 310.

When power is fed to the HDD 6 in a no-power feeding state, the spin-up time as the activation time is generally about several sec to several tens of sec. For example, when the image forming apparatus 1 executes the IP-FAX function, it needs to respond within a predetermined time of 5 sec to a request command for apparatus information or the like from a SIP server. In some cases, the image forming apparatus 1 cannot respond within the predetermined time owing to the spin-up time of the HDD 6. In this embodiment, in order to prevent a situation in which the image forming apparatus 1 cannot respond within the predetermined time, the second sleep mode in which power is fed even to the HDD 6 in addition to the CPU 301 and the disk controller 306 is set.

In the image forming apparatus 1, a storage requiring no spin-up time may be mounted at the portion of the HDD 6, instead of the HDD. Such a storage is, for example, an SSD (Solid State Drive). The SSD does not require the spin-up time, unlike the HDD, and can operate immediately after power feeding. When the SSD is mounted at the portion of the HDD 6, the image forming apparatus 1 is shifted from the standby mode not to the second sleep mode but to the deep sleep mode. This configuration can prevent unwanted power consumption during the sleep mode that is generated owing to the shift to the second sleep mode though the SSD for which the spin-up time need not be considered is mounted at the portion of the HDD 6.

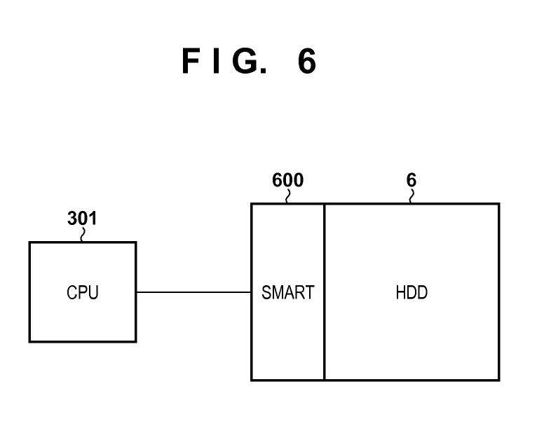

In this embodiment, therefore, SMART information is acquired by a SMART function from a SMART information storage unit 600 in a storage mounted at the portion of the HDD 6, and it is determined which of the HDD and the SSD is mounted. SMART stands for Self-Monitoring Analysis and Reporting Technology, and is information stored in the storage for the purpose of early detection of a trouble of the hard disk drive and prediction of a fault. The SMART information describes, for example, the average value/maximum value of the spin-up time of the storage and a spin-up failure, and can be updated at a predetermined interval. FIG. 6 is a block diagram showing the relationship between the CPU 301, the HDD 6, and the SMART information storage unit 600 in FIG. 5. At the portion of the HDD 6, the HDD is mounted in some case, and the SSD is mounted in other cases.

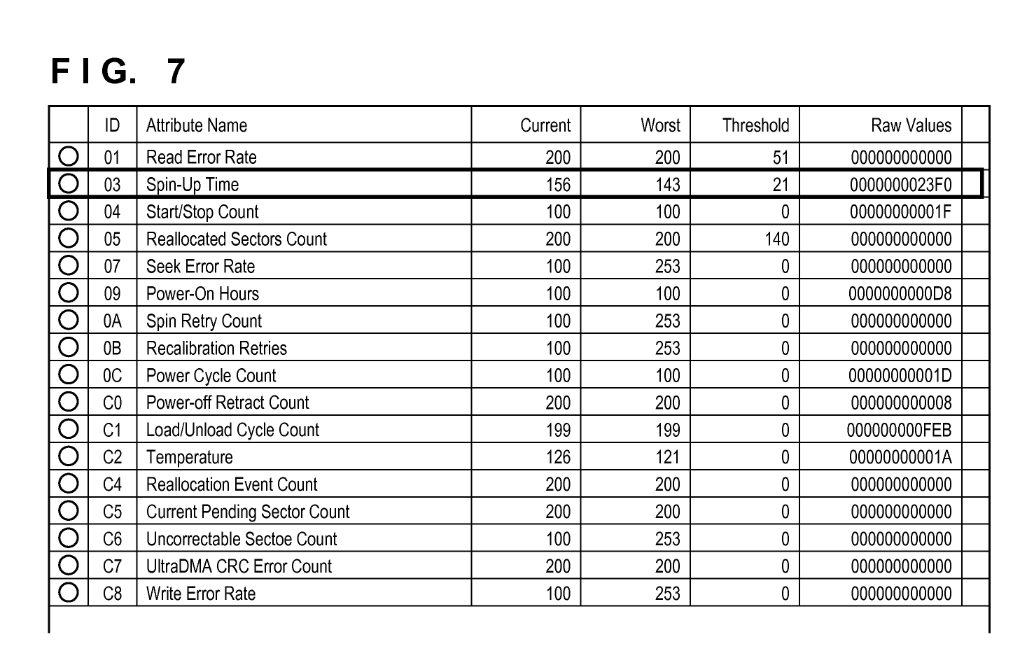

FIG. 7 is a table showing an example of a description regarding SMART information. As shown in FIG. 7, various characteristics such as the spin-up time and temperature information are stored. For example, as the spin-up time, the time until the disk reaches a predetermined rotational speed after it starts rotating. In this embodiment, the spin-up time in the SMART information is used to determine a sleep mode serving as a shift destination.

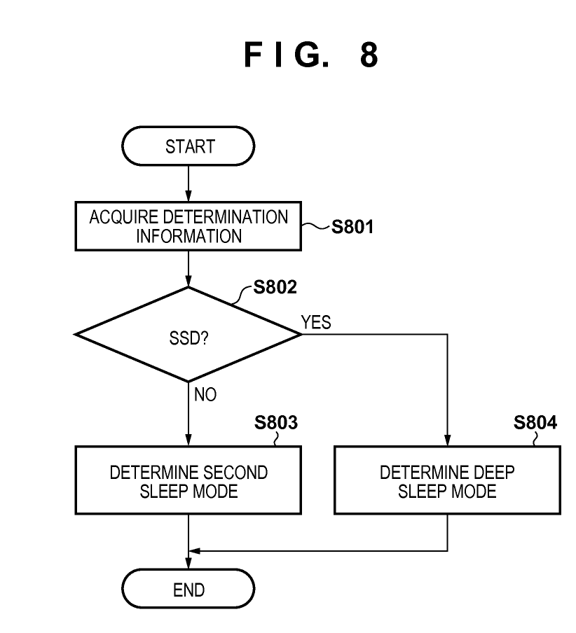

FIG. 8 is a flowchart showing the procedures of shift control processing to the sleep mode. At the time of activating the image forming apparatus 1 or at the time of changing the setting of the shift to the sleep mode by the user, the controller 3 acquires, from a storage mounted at the portion of the HDD 6, information for determining the storage (step S801). Based on the determination information acquired in step S801, the controller 3 determines which of the HDD and the SSD is the mounted storage (step S802). The determination of which of the HDD and the SSD is mounted is performed based on which of an HDD-specific value and an SSD-specific value is indicated by the contents of an area provided commonly for the HDD/SSD in the SMART information storage unit 600.

If the controller 3 determines that the HDD is mounted, it determines the second sleep mode as a shift destination mode from the standby mode (step S803). If the controller 3 determines that the SSD is mounted, it determines the deep sleep mode as a shift destination mode (step S804). After the processes in steps S803 and S804, the processing in FIG. 8 ends.

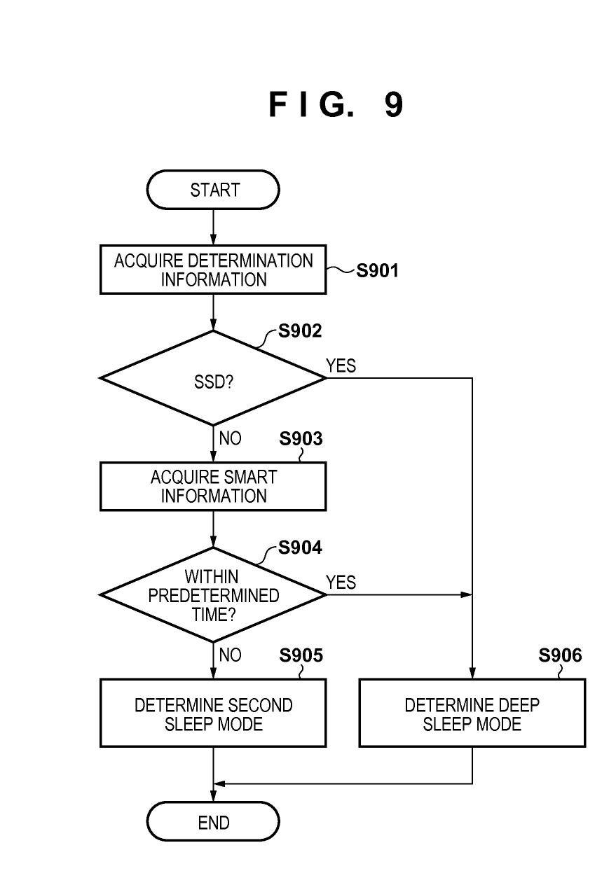

FIG. 9 is another flowchart showing the procedures of shift control processing to the sleep mode. In the processing of FIG. 8, a sleep mode serving as a shift destination is determined based on which of the HDD and the SSD is a mounted storage. However, the spin-up time is sometimes very short depending on the capacity or model of the HDD. For example, there is an HDD (to be referred to as a high-speed HDD hereinafter), spin-up of which is completed in about 2 sec. In this case, power feeding need not be maintained at the time of shifting to the sleep mode. In the processing of FIG. 9, the spin-up time of the storage is dynamically acquired, as needed, and which of the deep sleep mode and the second sleep mode is the shift destination mode is determined based on the spin-up information.

In this processing, the type of storage mounted at the portion of the HDD 6 is determined based on SMART information stored in the SMART information storage unit 600 of the storage. When it is determined that the storage is the SSD, the deep sleep mode is determined as the shift destination mode. When it is determined that the storage is the HDD, whether a response within a predetermined time is possible is determined based on the spin-up time in the SMART information. This determination is made based on, for example, whether the total time of the spin-up time and the time taken to send back response data to an external request falls within the predetermined time. If it is determined that the response in the predetermined time is possible, the deep sleep mode is determined as the shift destination mode. If it is determined that the response within the predetermined time is impossible, the second sleep mode is determined as the shift destination mode.

That is, when the high-speed HDD is highly likely to be mounted in the image forming apparatus 1, it is determined which of the HDD and the SSD is the storage. Even if it is determined that the HDD is mounted, it is further determined whether a response within the predetermined time is possible. Based on the determination result, a sleep mode to which the image forming apparatus 1 shifts is determined. This processing will be explained with reference to FIG. 9.

At the time of activating the image forming apparatus 1 or at the time of changing the setting to the sleep mode by the user, the controller 3 acquires, from a storage mounted at the portion of the HDD 6, information for determining the storage (step S901). Based on the determination information acquired in step S901, the controller 3 determines which of the HDD and the SSD is the mounted storage (step S902). The determination in step S902 is performed based on which of an HDD-specific value and an SSD-specific value is indicated by the contents of an area provided commonly for the HDD/SSD in the SMART information storage unit 600, as in step S802. If the controller 3 determines that the SSD is mounted, it determines the deep sleep mode as a shift destination mode (step S906). After the processing in step S906, the processing in FIG. 9 ends.

If the controller 3 determines that the HDD is mounted, it acquires the spin-up time from the SMART information acquired in step S901 (step S903). Based on the spin-up time acquired in step S903, the controller 3 determines whether a response within a predetermined time is possible (step S904). This determination is made based on, for example, whether the total time of the spin-up time and the time taken to send back response data to an external request falls within the predetermined time. If the controller 3 determines that the response in the predetermined time is possible, it determines the deep sleep mode as the shift destination mode (step S906). If the controller 3 determines that the response in the predetermined time is impossible, it determines the second sleep mode as the shift destination mode (step S905). After the processing in step S905, the processing in FIG. 9 ends.

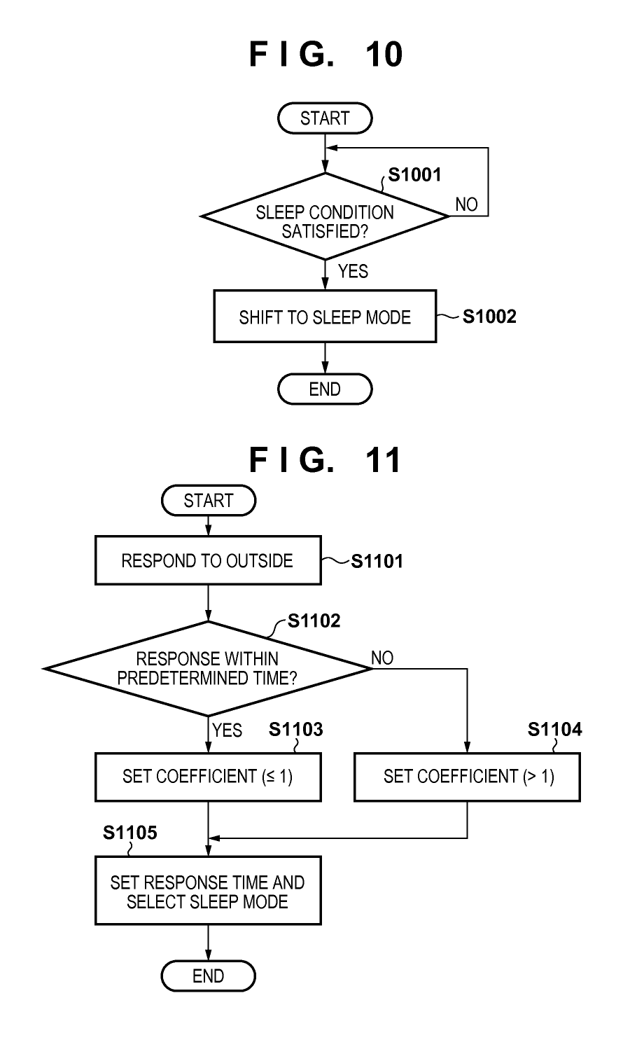

Although each process is performed by the controller 3 in the above description, it is implemented by reading out, to the RAM, a program stored in a storage area such as the ROM, and executing the program by the CPU 301 (this also applies to FIGS. 10 and 11 (to be described later)). The shift destination mode determined in FIGS. 8 and 9 is temporarily stored in a storage area such as the RAM, and is referred to when a shift condition from the standby mode to the sleep mode is satisfied. The case in which the shift condition is satisfied is, for example, a case in which a state in which an operation by the user is not accepted continues for a predetermined time.

FIG. 10 is a flowchart showing the procedures of processing of shifting the image forming apparatus 1 to the sleep mode. At a predetermined time interval, the controller 3 determines whether the condition to shift to the power saving mode is satisfied (step S1001). The shift condition is a state in which the state in which an operation by the user is not accepted continues for a predetermined time.

If it is determined in step S1001 that the shift condition to the sleep mode is satisfied, power feeding to each unit is controlled to shift to the sleep mode determined in FIG. 8 or 9 (step S1002). The processing in step S1002 is performed by a power supply control unit that is provided separately from the controller 3 and controls power supply to each unit of the image forming apparatus 1. The power supply control unit controls power supply by, for example, switching opening/closing of a power supply path to each unit in accordance with a shift destination mode temporarily stored in a storage area such as the RAM in the above-described way. When it is determined that the shift destination is the deep sleep mode, the power supply control unit controls power feeding to each unit in accordance with FIG. 4. When it is determined that the shift destination is the second sleep mode, the power supply control unit controls power feeding to each unit in accordance with FIG. 5. After the processing in step S1002, the processing in FIG. 10 ends.

FIG. 11 is still another flowchart showing the procedures of shift control processing to the sleep mode. In FIG. 9, it is determined which of the HDD and the SSD is a storage mounted at the portion of the HDD 6. If it is determined that the HDD is mounted, it is further determined whether a response within a predetermined time is possible. Based on the determination result, a sleep mode to which the image forming apparatus 1 shifts is determined.

Even when the HDD is a high-speed HDD, for example, the viscosity of a fluid dynamic bearing owing to aging or a low temperature may rise to increase the rotation load and prolong the spin-up time. That is, even when the total time of the spin-up time and the time taken to respond to an external request falls within the predetermined time, if the spin-up time becomes long owing to aging, the total time may not fall within the predetermined time. In such a case, power feeding to the HDD needs to be maintained in the sleep mode. In this processing, therefore, the time taken for a response to the outside such as the SIP server is periodically acquired, and a sleep mode serving as a shift destination is properly determined based on the acquired time.

This processing will be explained with reference to FIG. 11. The controller 3 measures and acquires a response time taken for a response to the outside such as the SIP server periodically (for example, every week) (step S1101). The processing in step S1101 is performed when, for example, the processing in FIG. 8 or 9 is performed, and the image forming apparatus 1 shifts to the sleep mode, then receives an external request command, and performs sleep return. The measured response time is saved in a storage area such as the ROM. That is, in the processing of FIG. 11, a response time acquired in step S1101 when the previous processing of FIG. 11 was performed is currently saved.

The controller 3 determines whether the response in step S1101 has been sent back within the predetermined time (step S1102). If the controller 3 determines that the response has been sent back within the predetermined time, it advances to step S1103. If the controller 3 determines that the response has not been sent back within the predetermined time, it advances to step S1104. For example, when executing the IP-FAX function, the image forming apparatus 1 needs to respond within 5 sec to an external notification. In this case, if the controller 3 determines that the image forming apparatus 1 has responded within 5 sec (response success), it advances to step S1103. If the controller 3 determines that the image forming apparatus 1 has not responded within 5 sec (response failure), it advances to step S1104.

The response failure will be explained. In step S1104, the controller 3 calculates the difference between the predetermined time and the response time measured in step S1101. The controller 3 sets a coefficient of larger than 1 in accordance with the calculated difference. In step S1105, the controller 3 multiplies the currently saved response time by the coefficient set in step S1104, thereby setting a new response time. If the new response time is equal to or shorter than the predetermined time, the controller 3 determines the deep sleep mode as a shift destination sleep mode at the time of the next and subsequent shifts. If the new response time is longer than the predetermined time, the controller 3 determines the second sleep mode as a shift destination sleep mode at the time of the next and subsequent shifts.

Since the coefficient of larger than 1 is set in step S1104, the new response time becomes longer than the previous response time. As a result, for example, the prolongation of the spin-up time owing to aging can be appropriately reflected in the next shift to the sleep mode. After the processing in step S1105, the processing in FIG. 11 ends.

Next, the response success will be explained. In step S1103, the controller 3 calculates the difference between the predetermined time and the response time measured in step S1101. The controller 3 sets a coefficient of 1 or smaller in accordance with the calculated difference. In step S1105, the controller 3 multiplies the currently set response time by the coefficient set in step S1103, thereby setting a new response time. If the new response time is equal to or shorter than the predetermined time, the controller 3 determines the deep sleep mode as a shift destination sleep mode at the time of the next and subsequent shifts. If the new response time is longer than the predetermined time, the controller 3 determines the second sleep mode as a shift destination sleep mode at the time of the next and subsequent shifts.

Since the coefficient of 1 or smaller is set in step S1103, the new response time becomes equal to or shorter than the previous response time. As a result, for example, the shortening of the spin-up time owing to a change of the HDD can be appropriately reflected in the next shift to the sleep mode. After the processing in step S1105, the processing in FIG. 11 ends.

In steps S1103 and S1104, a new response time is determined by setting a coefficient. However, another method is also applicable as long as the tendency (whether the response time becomes longer or shorter) from the previous response time to the current response time can be reflected in the previous response time. For example, the previous response time may be updated by the response time acquired in step S1101.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-240365, filed Nov. 27, 2014, which is hereby incorporated by reference herein in its entirety.

What is claimed is:

1. An image forming apparatus having a standby state, and a power saving state in which power consumption is lower than power consumption in the standby state, the power saving state including a first power saving state in which power supply to a storage is stopped, and a second power saving state in which power supply to the storage is maintained, comprising:
an acquisition unit configured to acquire information of the storage; and
a determination unit configured to determine, based on the information of the storage that is acquired by the acquisition unit, one of the first power saving state and the second power saving state to which the image forming apparatus shifts when the image forming apparatus shifts to the power saving state.

2. The apparatus according to claim 1, wherein
the information of the storage includes information representing a type of the storage,
when the information of the storage represents a storage requiring a predetermined activation time in returning from the power saving state to the standby state, the determination unit determines shift to the second power saving state, and
when the information of the storage does not represent the storage requiring the predetermined activation time in returning from the power saving state to the standby state, the determination unit determines shift to the first power saving state.

3. The apparatus according to claim 2, further comprising a second determination unit configured to, when the information of the storage represents the storage requiring the predetermined activation time in returning from the power saving state to the standby state, determine whether the activation time satisfies a condition that the image forming apparatus shifts to the first power saving state,
wherein when the second determination unit determines that the condition that the image forming apparatus shifts to the first power saving state is satisfied, the determination unit determines shift to the first power saving state, and
when the second determination unit determines that the condition that the image forming apparatus shifts to the first power saving state is not satisfied, the determination unit determines shift to the second power saving state.

4. The apparatus according to claim 3, wherein in a case in which a response to a request command from an outside is defined to be performed within a predetermined time when the image forming apparatus performs predetermined communication with the outside,
when the response to the request command within the predetermined time is possible even if the activation time is taken, the second determination unit determines that the condition that the image forming apparatus shifts to the first power saving state is satisfied, and
when the response to the request command within the predetermined time is impossible if the activation time is taken, the second determination unit determines that the condition that the image forming apparatus shifts to the first power saving state is not satisfied.

5. The apparatus according to claim 4, wherein the predetermined communication includes reception of a request command from a SIP server when executing an IP-FAX function.

6. The apparatus according to claim 4, further comprising a storage unit configured to store a response time to the request command,
wherein the response time includes the activation time.

7. The apparatus according to claim 6, further comprising:
a second acquisition unit configured to, when the image forming apparatus receives the request command from the outside in the power saving state and returns to the standby state, acquire a time taken for a response to the request command; and
an update unit configured to update the response time stored in the storage unit based on the time taken for the response that is acquired by the second acquisition unit.

8. The apparatus according to claim 7, wherein the update unit updates the response time stored in the storage unit in accordance with a difference between the predetermined time and the time taken for the response that is acquired by the second acquisition unit.

9. The apparatus according to claim 1, further comprising a shift unit configured to, when a condition that the image forming apparatus shifts to the power saving state is satisfied, execute processing of shifting to one of the first power saving state and the second power saving state determined by the determination unit.

10. The apparatus according to claim 1, wherein the storage is one of a hard disk requiring a predetermined spin-up time, and a storage requiring no spin-up time.

11. The apparatus according to claim 10, wherein
the storage is one of the hard disk and an SSD (Solid State Drive), and
the acquisition unit acquires the information of the storage by a SMART function from the storage.

12. An image forming apparatus control method to be executed in an image forming apparatus having a standby state, and a power saving state in which power consumption is lower than power consumption in the standby state, the power saving state including a first power saving state in which power supply to a storage is stopped, and a second power saving state in which power supply to the storage is maintained, the method comprising:
acquiring information of the storage; and
determining, based on the acquired information of the storage, one of the first power saving state and the second power saving state to which the image forming apparatus shifts when the image forming apparatus shifts to the power saving state.

13. A non-transitory computer-readable storage medium storing a program for causing a computer to execute an image forming apparatus control method to be executed in an image forming apparatus having a standby state, and a power saving state in which power consumption is lower than power consumption in the standby state, the power saving state including a first power saving state in which power supply to a storage is stopped, and a second power saving state in which power supply to the storage is maintained, the method including:
acquiring information of the storage; and
determining, based on the information of the storage that is acquired in the acquisition step, one of the first power saving state which is included in the power saving state and in which power supply to the storage is stopped, and the second power saving state which is included in the power saving state and in which power supply to the storage is maintained, to which the image forming apparatus shifts when the image forming apparatus shifts to the power saving state in which power consumption is lower than power consumption in the standby state.
